(19) United States
(12) Patent Application Publication
(10) Pub. No.: US 2026/0105351 A1
(43) Pub. Date: Apr. 16, 2026

(54) EFFICIENT DISTRIBUTED PROTOCOL FOR DIVERSE GOSSIP LEARNING

(71) Applicant: Dell Products L.P., Round Rock, TX (US)

(72) Inventors: Paulo Abelha Ferreira, Rio de Janeiro (BR); Isabella Costa Maia, Bertioga (BR); Julia Drummond Noce, Rio de Janeiro (BR)

(21) Appl. No.: 18/912,368

(22) Filed: Oct. 10, 2024

(51) Int. Cl. G06N 20/00

(52) U.S. Cl. CPC G06N 20/00

(57) ABSTRACT

One example method may be performed by a node operating in an edge environment that includes peer nodes, determining an expected return of sending a ML model resident at the node, to one of the peer nodes, maintaining a first data structure that includes respective returns for each of the peer nodes, and a second data structure that includes respective contributions for each of the peer nodes, sampling the first data structure to obtain a first subsample including the peer nodes with maximum returns, and the second data structure to obtain a second subsample include the peer nodes with minimum contributions, combining the first subsample with the second subsample to obtain a final subset of peers that includes a mix of one or more maximum expected return peers and one or more minimal contribution peers, and sending the ML model to the peer nodes of the final subset of peers.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to distributed learning in edge environments. More particularly, at least some embodiments relate to systems, hardware, software, computer-readable media, and methods, for an efficient distributed protocol for diverse gossip learning.

### BACKGROUND

Gossip learning is an asynchronous protocol for learning models from fully distributed data without central control. It is a form of distributed learning that can function at scale between large number of nodes. Gossip learning has been proposed as a research area for future scalability and federation of machine learning at the edge.

While they show potential, current approaches to gossip learning face a variety of challenges. One such challenge is that current approaches to gossip learning are not well suited for dealing with shifting network topologies. Another challenge is that current approaches to gossip learning struggle to maximize model diversity. As a final example, current approaches to gossip learning are not well suited to minimize network loading.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of various current challenges in the field of gossip learning, and aspects of one embodiment of an approach for dealing with those challenges.

FIG. 2 discloses aspects of a process for online learning of expected return, according to one embodiment.

FIG. 3 discloses aspects of an efficient data structure for peer sampling, according to one embodiment.

FIG. 4 discloses aspects of a process for adaptive subsampling of peers, according to one embodiment.

FIG. 5 discloses aspects a computing entity configured and operable to perform any of the disclosed methods, processes, and operations.

### DETAILED DESCRIPTION OF SOME EXAMPLE EMBODIMENTS

Embodiments disclosed herein generally relate to distributed learning in edge environments. More particularly, at least some embodiments relate to systems, hardware, software, computer-readable media, and methods, for an efficient distributed protocol for diverse gossip learning.

One or more embodiments are concerned with distributed learning, such as among a group of peer nodes operating in an edge environment. A method according to one embodiment may operate to maximize model diversity and contribution across a variety of nodes participating in a gossip learning process. More particularly, a method according to one embodiment may operate to strike a balance between each node maximizing the spread of its models to other peers—this process is also referred to herein as ‘exploitation’ of expected return-while also maximizing model diversity through spreading its models to peers that have not merged much with them—this process is also referred to herein as ‘exploration’ of other subsets of the network.

Thus, a method according to one embodiment may comprise operations including: formulating an expected return of a node sending its trained model to a peer; performing an efficient accounting of the expected return and expected diversity using two efficient data structures; performing a smart subsampling of the peers through a modification of the original gossip learning template protocol; and, distributing, by a node, its model to peers identified in the smart subsampling.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may be adaptable to shifting network topologies. As another example, and embodiment may operate to improve, or maximize, relative to conventional approaches, model diversity among a group of peers. An embodiment may operate to reduce, or minimize, relative to conventional approaches, network usage during a gossip learning process. Various other advantages of one or more example embodiments will be apparent from this disclosure.

### A. CONTEXT FOR SOME EMBODIMENTS

The following is a discussion of aspects of a context for various embodiments. This discussion is not intended to limit the scope of the claims or this disclosure, or the applicability of the embodiments, in any way.

As noted above, one or more embodiments are concerned with gossip learning processes. Gossip learning is an asynchronous protocol for learning models from fully distributed data, but without central control of the learning process.

A gossip learning process may begin when a node, such as a node in a distributed edge environment that comprises multiple nodes, initializes a local model and its age. This local model is then periodically sent to another node in the network, which merges the receive model with its own local model by averaging the parameters of the two models. The combined, or merged, model is trained with local data and sent to another node, thus restarting the model merge and training process again. The models take random walks in the network and are updated when visiting a node. The possible update methods are the same as in the case of Federated Learning (FL) and compression can be applied as well.

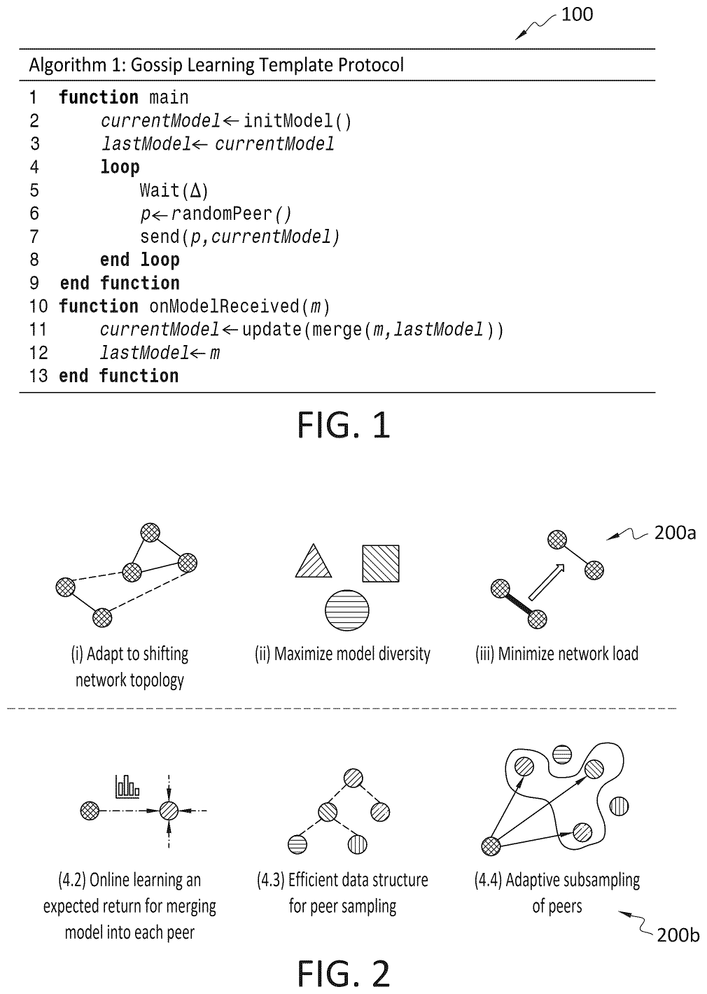

With attention now to FIG. 1, an algorithm 100—denoted as ‘Algorithm 1’—describes Gossip Learning method pseudocode. The main loop is executed at each edge node: a random peer is chosen among the other participants in the cluster and the current model is sent to another node. When the node receives the new model, it merges it with the last model previously received and updates the resulting model by performing local training. The resulting model is then stored locally for prediction and for gossiping with peers until a new model is received and the process is repeated.

The merge method may be diverse. In this disclosure, an embodiment may average the model parameters. Moreover, an embodiment may also use a simple sampling method as a compression mechanism. This means that instead of sending the full model to the neighbor, a node sends only a subset of the parameters of the model. In higher compression settings, gossip learning can outperform federated learning. However, if one considers the download traffic to be essentially free, that is, there are no penalties associated with download traffic, Federated Learning is more favorable, as disclosed in “Hegedús, István, Gábor Danner, and Márk Jelasity. ‘Gossip learning as a decentralized alternative to federated learning.’ IFIP International Conference on Distributed Applications and Interoperable Systems. Springer, Cham, 2019,” which is incorporated herein in its entirety by this reference.

### B. OVERVIEW OF ASPECTS OF AN EMBODIMENT

### B.1 Introduction

Gossip learning is an asynchronous protocol for learning models from fully distributed data without central control. It is a form of distributed learning that can function at scale between large number of nodes. It was recently proposed as a research area for future scalability and federation of machine learning (ML) at the edge.

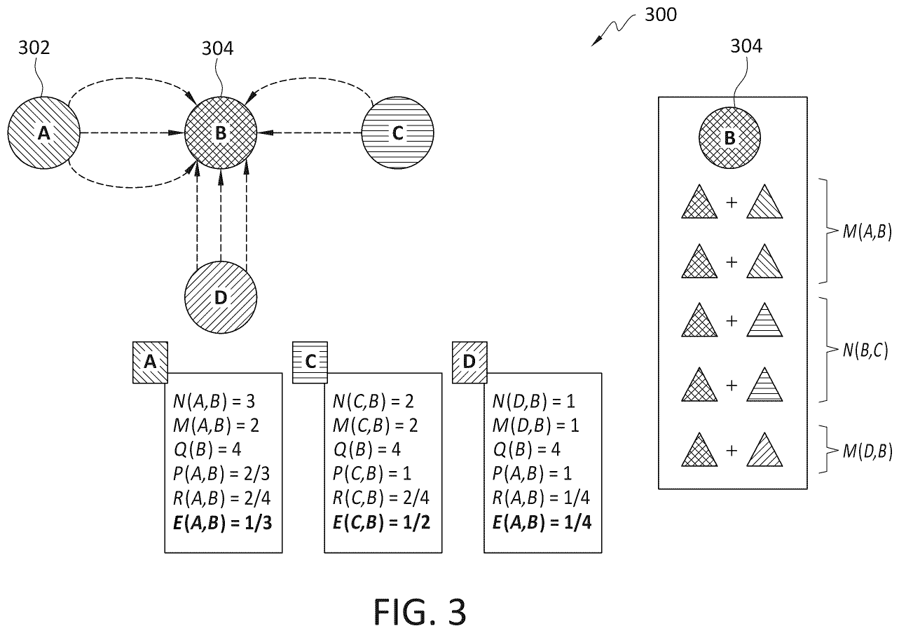

One or more embodiments are directed to a protocol for Gossip Learning (GL) that improves on model diversity while keeping network usage at a minimum. One or more embodiments comprise a smart protocol that, as indicated in FIG. 2 at 200a, meets various challenges by: (1) adapting to network topology; (2) maximizing model diversity; and (3) minimizing network usage. As discussed in more detail below, and shown in FIG. 2 at 200b, an embodiment may implement these functionalities by performing various operations including, for example: (i) learning, online, an expected return for merging a model into a peer model; (ii) constructing and using an efficient data structure for peer sampling; and (iii) performing an adaptive subsampling of peers.

### B.2 Discussion

For intelligent edge solution, data gravity, privacy and regulations limit the transmission of Machine Learning (ML) datasets across nodes and between nodes and central servers. Therefore, there is a need for distributed training solutions such as Federated Learning (FL) and Gossip Learning (GL). In such solutions, data is kept at each node and only models are communicated between and among nodes. In the case of FL, there is a requirement for a central server for aggregating models and syncing them back to edge nodes. GL, on the other hand, allows for a fully distributed protocol at the price of possibly decreasing diversity, that is, the type and/or number of participating node, across resulting models. GL may be used in cases where a customer has distributed operations across different regions and would like to build ML models that work well for all of those operations and regions. One such case could be the logistics or manufacturing domains, where there may be a need for ML models for smart factories or docks.

This disclosure comprises, among other things, a protocol for Gossip Learning that (a) improves on model diversity while (b) keeping network usage at a minimum. In more detail, an embodiment comprises a smart protocol that can adapt to changes in network topology while maximizing model diversity and minimizing network usage. Thus, an embodiment may construct and/or maintain an efficient data structure at each node that keeps track of an “expected return” over sending the models of that node to a given peer node. In Gossip Learning (GL), one way to minimize network usage is to select a subsample of all peers to which a model will be sent. One embodiment comprises a protocol for balanced ‘exploitation’ (of maximum participation of the model of a given node into one or more peer nodes) and ‘exploration’ (of maximizing diversity by spreading the model of a node model into one or more other nodes). Thus, one embodiment may comprise the implementation and use of (1) an expected return formulation that enables exploitation of peers that maximize success of model merging for each node (Online Learning of Expected Return), (2) efficient use of data structure and metadata for peer sampling, and (3) smart and adaptive subsampling of peers to minimize network usage while enabling a good balance between exploitation and exploration.

### C. DETAILED DISCUSSION

### C.1 Introduction

As noted above, an embodiment comprises a protocol for the recent area of Gossip Learning, which is a form of at scale distributed learning for ML models. One embodiment may maximize model diversity and contribution across many different node participants in Gossip learning. In Gossip Learning, each node trains their model and sends the trained model to node peers that then merge this model with their own model. An embodiment may operate to strike a good balance between each node maximizing the spread of their models to other peers (‘exploitation’ of expected return) and also maximizing model diversity through spreading their models to peers that haven't merged much with them (‘exploration’ of other subsets of the network).

To these ends, one or more embodiment may comprise the following elements: a formulation of this expected return of a node sending their trained model to a peer; an efficient accounting of this expected return and expected diversity using two efficient data structures; and a smart subsampling of the peers through a modification of the original Gossip learning template protocol. These elements are addressed in detail below.

### C.2 Online Learning of Expected Return

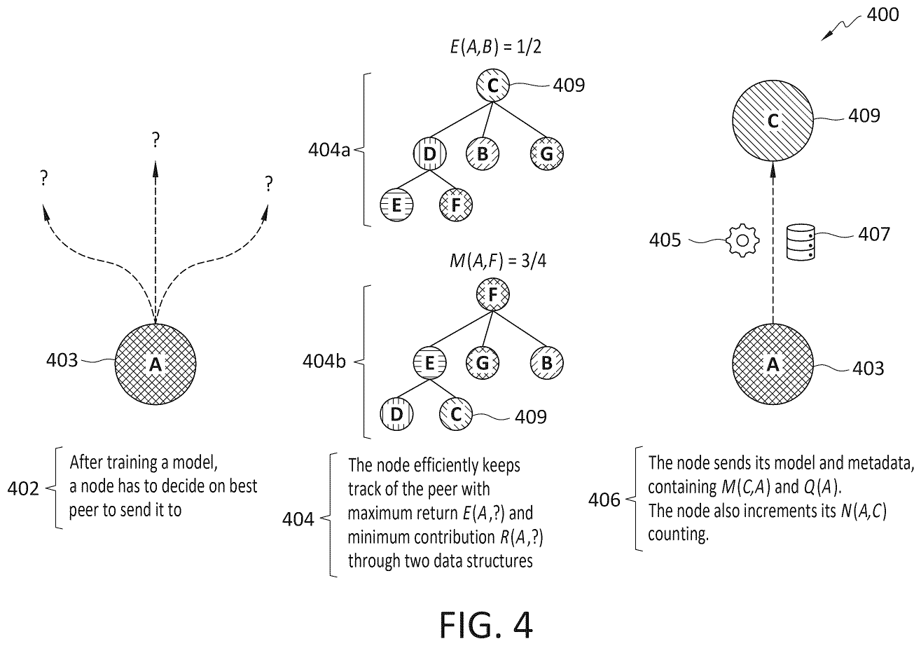

In an embodiment, the “expected return” of A sending a model to B is defined in a rigorous way so that each node can sort their peers by “expected return” and then subsample the best ones as receivers for its model. In an embodiment, and with reference now to the example schema 300 of FIG. 3 which discloses an embodiment of online learning of “expected return,” each node A 302 keeps track of three quantities per peer node B 304:
N(A, B): number of times that A sent its model to B;
M(A, B): number of times that B performed a merge with the model of A; and
Q(B): number of merges that B has done in total.

Thus, the quantity

$$P ( A , B ) = \frac{M ( A , B )}{N ( A , B )}$$

represents the probability that a merge will occur if A sends its model to B. And the return R(A, B) obtained by A sending its model to B is the expected participation of A's model in all of B's merges, or

$$R ( A , B ) = \frac{M ( A , B )}{Q ( B )} .$$

The “expected return” from node A 302 to node B 304 is then given by:

$$E ( A , B ) = R ( A , B ) \cdot P ( A , B )$$

That is, the “expected return” is a measurement of the extent to which can it be expected that a new model sent from A to B will participate in B's merges.

With continued reference to FIG. 3, it can be seen that the schema 300 considers both (1) the success rate of merging a model with a peer and (2) the participation rate of a peer in another peer's model merging. Each peer tries to maximize its participation in all of the other peer's models through a decentralized optimization guided by the “expected return” equation presented above.

### C.3 Efficient Data Structure for Peer Sampling

Every time a node A sends out its model to a peer B, node A also sends the updated information of each peer's participation in the merges M(B, A) of node A, and the total number of merges Q(A) of node A. Conversely, each node keeps two priority queue heap structures that are efficiently updated and consulted. Each node efficiently keeps track of the peer with maximum return E(A, ?) and minimum contribution R(A, ?) through these two heap data structures.

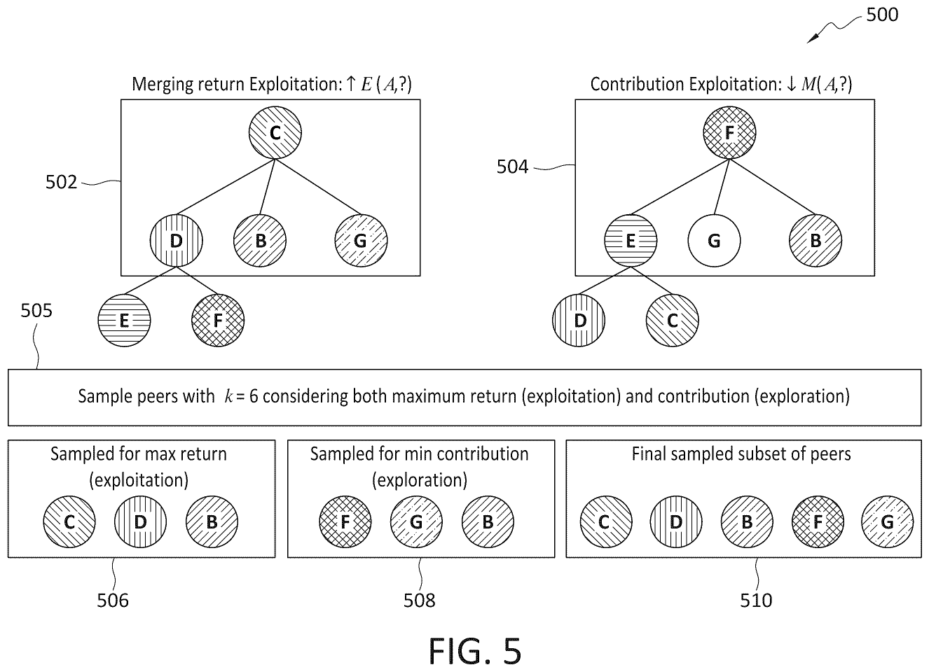

With reference now to the example of FIG. 4, a method 400 is disclosed that may be used by a node to keep track of best peers to send its model to. The operation 402 comprises, after training an ML model, a node A 403 must decide on the best set of peers to send its model to. As shown at 404, the node A 403 may keep track, using two respective data structures 404a and 404b, of the respective peers with (1) the maximum return E(A, ?) and (2) the minimum contribution R(A, ?).

An aim of an embodiment of the method 400 may be to maximize the spreading of the model of node A 403 through merges in the network. To do this, there may be a need to know, for which peers does node A 403 have maximum success change of achieving a merge with, and node A 403 may also try out merging its model in nodes that have not been tried yet. For each peer that node A 403 has decided to send its model to, and as shown at 406, node A 403 will send the model 405 along with metadata 407 containing Q(A) so that the peer node C 409 receiving the metadata 407 can update its Q(A) value.

### C.4 Adaptive Subsampling of Peers

In addition to optimizing for maximizing its model merging into other peers, each node also tries to, randomly or according to a specified schedule or time interval for example, send its model to peers where that model has not previously been sent, or to peers where there is minimum merging with the model of that node. This approach may help counterbalance the greedy search for best return, and may help increase model and/or node diversity in an adaptive manner.

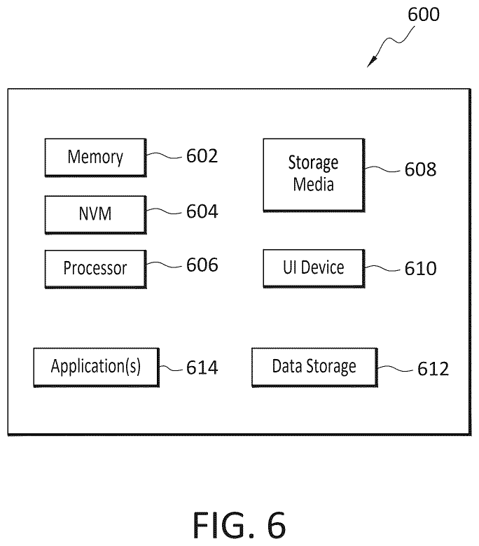

Turning next to FIG. 5, an example schema 500 for adaptive subsampling of peers is disclosed. In this example, a node A consults its two heap data structures 502 and 504 to determine the subset of peers to communicate with, that is, the peers to which the node A will send its model.

Initially, the node A consults the first e peers with maximum return E (A, ?) in its maximum return heap structure 502, and then node A consults the first r peers with minimum return R(A, ?) in its minimum contribution heap structure 504. Naturally, peers who have never merged their model with the model of node A will have R(A, ?)=0 and thus will be present at the top of the minimum contribution heap structure.

After selecting the maximum return subset 506 of nodes, and the minimal contribution peer subset 508 of nodes, node A will combine these two subsets into a final 510 subset of nodes with which to communicate. Given a pre-set parameter k of a maximum number of peers to choose 505 for communication, node A will randomly select k/2 peers from the e subset and k/2 from the r subset. In the example of FIG. 5, k=6, so that there are 3 peer nodes in the subset 506, and 3 peer nodes in the subset 508. The union between these two subsets 506 and 508 will determine the peers sampled. This will guarantee that there is a mix between maximum-expected-return peers (exploitation) included in the subset 506, and exploration peers included in the subset 508 (peers that have not merged much, or at all which, and could benefit from a merger of their respective models with the model of node A).

### C.5 Further Discussion

As disclosed herein, one or more embodiments may possess various useful features and aspects, although no embodiment is required to possess any of such features or aspects. The following examples are illustrative, but not exhaustive. One or more embodiments may be directed to addressing various challenges, and may comprise using a Gossip Learning algorithm in a framework that: (1) adapts to changes in a network topology; (2) maximizes model diversity among a group of nodes; and (3) minimizes network usage, such as network communication bandwidth. Thus, an embodiment may comprise various elements such as, but not limited to, (1) an expected return formulation that enables exploitation of peers that maximize success of model merging for each node—or “online learning of expected return,” (2) efficient use of data structures and metadata for peer sampling operation, and (3) smart and adaptive subsampling of peers to minimize network usage while providing a good balance between exploitation and exploration when identifying candidate nodes for model merging.

### D. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. FURTHER EXAMPLE EMBODIMENTS

Following are some further example embodiments. These are presented only by way of example and are not intended to limit the scope of this disclosure or the claims in any way.

Embodiment 1. A method, comprising: by a node operating in an edge environment that includes multiple peer nodes, determining an expected return of sending, by the node, a ML model resident at the node, to one of the peer nodes in the edge environment; maintaining, by the node, a first data structure that comprises respective returns for each of the peer nodes, and a second data structure that comprises respective contributions for each of the peer nodes; sampling, by the node, the first data structure to obtain a first subsample comprising the peer nodes with maximum returns, and the second data structure to obtain a second subsample comprising the peer nodes with minimum contributions; combining, by the node, the first subsample with the second subsample to obtain a final subset of peers that comprises a mix of one or more maximum expected return peers and one or more minimal contribution peers; and sending, by the node, the ML model to the peer nodes of the final subset of peers.

Embodiment 2. The method as recited in any preceding embodiment, wherein the node keeps track of parameters for each of the peer nodes, and the parameters comprise, for a peer node B, a number of times that the node has sent the ML model to the peer node B, a number of times that the peer node B has merged its ML model with the ML model of the node, and a number of merges performed by the peer node B.

Embodiment 3. The method as recited in any preceding embodiment, wherein the expected return is a function of a probability that a merge will occur if the node sends the ML model to one of the peer nodes, and the expected return is also a function of the return obtained by the node sending its ML model to one of the peer nodes.

Embodiment 4. The method as recited in embodiment 3, wherein the return is an expected participation of the ML model of the node in all model mergers effected at the one of the peer nodes.

Embodiment 5. The method as recited in any preceding embodiment, wherein the node seeks to maximize participation of the ML model in respective ML models of the peer nodes.

Embodiment 6. The method as recited in any preceding embodiment, wherein the first data structure and the second data structure comprise respective priority queue heap structures.

Embodiment 7. The method as recited in any preceding embodiment, wherein each of the peer nodes maintains a respective first data structure and a second data structure.

Embodiment 8. The method as recited in any preceding embodiment, wherein sending the ML model to the peer nodes of the final subset of peers consumes less computing resources than if the ML model were sent to all of the peer nodes.

Embodiment 9. The method as recited in any preceding embodiment, wherein one or both of the first data structure and the second data structure are automatically updated when a configuration change occurs in the edge environment.

Embodiment 10. The method as recited in any preceding embodiment, wherein any of the peer nodes that have never merged their respective ML model with the ML model of the node appear at a top of the second data structure.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for implementing gossip learning, comprising:
by a node operating in an edge environment that includes multiple peer nodes, determining an expected return of sending, by the node, a ML (machine learning) model resident at the node, to one of the peer nodes in the edge environment;
maintaining, by the node, a first data structure that comprises respective returns for each of the peer nodes, and a second data structure that comprises respective contributions for each of the peer nodes;
sampling, by the node, the first data structure to obtain a first subsample comprising the peer nodes with maximum returns, and the second data structure to obtain a second subsample comprising the peer nodes with minimum contributions;
combining, by the node, the first subsample with the second subsample to obtain a final subset of peers that comprises a mix of one or more maximum expected return peers and one or more minimal contribution peers; and
sending, by the node, the ML model to the peer nodes of the final subset of peers.

2. The method as recited in claim 1, wherein the node keeps track of parameters for each of the peer nodes, and the parameters comprise, for a peer node B, a number of times that the node has sent the ML model to the peer node B, a number of times that the peer node B has merged its ML model with the ML model of the node, and a number of merges performed by the peer node B.

3. The method as recited in claim 1, wherein the expected return is a function of a probability that a merge will occur if the node sends the ML model to one of the peer nodes, and the expected return is also a function of the return obtained by the node sending its ML model to one of the peer nodes.

4. The method as recited in claim 3, wherein the return is an expected participation of the ML model of the node in all model mergers effected at the one of the peer nodes.

5. The method as recited in claim 1, wherein the node seeks to maximize participation of the ML model in respective ML models of the peer nodes.

6. The method as recited in claim 1, wherein the first data structure and the second data structure comprise respective priority queue heap structures.

7. The method as recited in claim 1, wherein each of the peer nodes maintains a respective first data structure and a second data structure.

8. The method as recited in claim 1, wherein sending the ML model to the peer nodes of the final subset of peers consumes less computing resources than if the ML model were sent to all of the peer nodes.

9. The method as recited in claim 1, wherein one or both of the first data structure and the second data structure are automatically updated when a configuration change occurs in the edge environment.

10. The method as recited in claim 1, wherein any of the peer nodes that have never merged their respective ML model with the ML model of the node appear at a top of the second data structure.

11. A non-transitory storage medium having stored therein instructions that are executable by one or more hardware processors to perform operations comprising:
by a node operating in an edge environment that includes multiple peer nodes, determining an expected return of sending, by the node, a ML (machine learning) model resident at the node, to one of the peer nodes in the edge environment;
maintaining, by the node, a first data structure that comprises respective returns for each of the peer nodes, and a second data structure that comprises respective contributions for each of the peer nodes;
sampling, by the node, the first data structure to obtain a first subsample comprising the peer nodes with maximum returns, and the second data structure to obtain a second subsample comprising the peer nodes with minimum contributions;
combining, by the node, the first subsample with the second subsample to obtain a final subset of peers that comprises a mix of one or more maximum expected return peers and one or more minimal contribution peers; and
sending, by the node, the ML model to the peer nodes of the final subset of peers.

12. The non-transitory storage medium as recited in claim 11, wherein the node keeps track of parameters for each of the peer nodes, and the parameters comprise, for a peer node B, a number of times that the node has sent the ML model to the peer node B, a number of times that the peer node B has merged its ML model with the ML model of the node, and a number of merges performed by the peer node B.

13. The non-transitory storage medium as recited in claim 11, wherein the expected return is a function of a probability that a merge will occur if the node sends the ML model to one of the peer nodes, and the expected return is also a function of the return obtained by the node sending its ML model to one of the peer nodes.

14. The non-transitory storage medium as recited in claim 13, wherein the return is an expected participation of the ML model of the node in all model mergers effected at the one of the peer nodes.

15. The non-transitory storage medium as recited in claim 11, wherein the node seeks to maximize participation of the ML model in respective ML models of the peer nodes.

16. The non-transitory storage medium as recited in claim 11, wherein the first data structure and the second data structure comprise respective priority queue heap structures.

17. The non-transitory storage medium as recited in claim 11, wherein each of the peer nodes maintains a respective first data structure and a second data structure.

18. The non-transitory storage medium as recited in claim 11, wherein sending the ML model to the peer nodes of the final subset of peers consumes less computing resources than if the ML model were sent to all of the peer nodes.

19. The non-transitory storage medium as recited in claim 11, wherein one or both of the first data structure and the second data structure are automatically updated when a configuration change occurs in the edge environment.

20. The non-transitory storage medium as recited in claim 11, wherein any of the peer nodes that have never merged their respective ML model with the ML model of the node appear at a top of the second data structure.
